(19) United States
(12) Patent Application Publication
(10) Pub. No.: US 2025/0302078 A1
(43) Pub. Date: Oct. 2, 2025

(54) PREPARATION METHOD OF LOW-GLYCEMIC INDEX (GI) RICE

(71) Applicant: ANHUI AGRICULTURAL UNIVERSITY, Hefei (CN)

(72) Inventors: Xianfeng DU, Hefei (CN); Yuanyuan LI, Hefei (CN); Kai DU, Hefei (CN)

(73) Assignee: ANHUI AGRICULTURAL UNIVERSITY, Hefei (CN)

(21) Appl. No.: 19/237,071

(22) Filed: Jun. 13, 2025

Related U.S. Application Data
(63) Continuation-in-part of application No. 17/857,195, filed on Jul. 5, 2022.

(30) Foreign Application Priority Data
Jan. 21, 2022 (CN) 202210072109.0

(51) Int. Cl. A23L 7/196; A23L 5/30; A23L 7/10

(52) U.S. Cl. CPC A23L 7/1965; A23L 5/32; A23L 7/1975

(57) ABSTRACT

A preparation method of a low-glycemic index (GI) rice includes: washing indica paddy rice to remove impurities, soaking the indica paddy rice in water to obtain first indica paddy rice, and after the soaking, subjecting the first indica paddy rice to an ultrasonic treatment in water with a first preset volume to obtain second indica paddy rice; after the ultrasonic treatment is completed, filtering out the second indica paddy rice, and cooking the second indica paddy rice in water with a second preset volume to obtain third indica paddy rice; placing the third indica paddy rice in a vacuum bag for sealing, and subjecting the third indica paddy rice in the vacuum bag to an ultra-high pressure treatment in an autoclave filled with water with a third preset volume to obtained fourth indica paddy rice; air-cooling the fourth indica paddy rice, and refrigerating the fourth indica paddy rice in a refrigerator to obtained fifth indica paddy rice; after the refrigerating is completed, oven-drying the fifth indica paddy rice in a blast air oven for 1 h, stopping blast, maintaining a temperature of the blast air oven unchanged, performing tempering treatment on the fifth indica paddy rice, and then oven-drying the fifth indica paddy rice until a moisture content of the fifth indica paddy rice is less than 16% to obtain sixth indica paddy rice; and shelling the sixth indica paddy rice to obtain the low-GI rice.

### CROSS REFERENCE TO THE RELATED APPLICATIONS

This application is a continuation-in-part application of U.S. patent application Ser. No. 17/857,195, filed on Jul. 5, 2022, which claims priority to Chinese Patent Application No. 202210072109.0, filed on Jan. 21, 2022, the entire contents of each of which are incorporated herein by reference.

### TECHNICAL FIELD

The present disclosure relates to the technical field of rice processing, and in particular to a preparation method of a low-glycemic index (GI) rice.

### BACKGROUND

Rice is a staple food with a long history in China and is eaten by the largest number of people. The ways of eating rice are different by era and/or country. The history of changes from original brown rice to polished rice and then from polished rice to brown rice is also the history of changes in human cognition for nutritional functions of the staple food. When rice serves as a staple food, the problems of high starch content, high glycemic index (GI), and the like have always been the concern of health-conscious people, especially people with diabetes. Diet therapy is currently the main adjuvant therapy for diabetes, and its research focuses on low-GI foods. Ordinary rice and other staple foods have become contraindications for diabetics.

From the perspective of nutrition, low-GI rice has relatively-high nutritional values, because low-GI rice not only completely retains the nutrition of brown rice, but also absorbs some nutrients in rice husks during a cooking process. The dietary fiber, mineral, and vitamin contents in low-GI rice are significantly higher than that in untreated rice. The untreated rice refers to rice that has only undergone ordinary cooking operations and has not undergone ultrasonic treatment, ultra-high pressure treatment, etc. At present, the low-GI foods on the market are mainly flour products such as biscuits, bread, and steamed buns, and there are relatively few low-GI staple foods safe for diabetics.

The existing technologies for GI reduction include as follows: (1) an extract capable of inhibiting the activity of a-amylase is added to a product to achieve the purpose of GI reduction; (2) miscellaneous grains and rice are mixed, crushed, and then subjected to granulation, thereby achieving the purpose of GI reduction; (3) miscellaneous grains and rice are modified by extrusion, puffing, recombination, or the like to change the shapes and structures of the miscellaneous grains and rice; and (4) an organic acid and a microwave treatment are used in combination to reduce GI. However, the miscellaneous grains obtained after modification and granulation have problems such as poor taste and cannot be widely accepted by consumers; and the recombination or exogenous substance addition is resisted by people who pursue natural staple foods, and the combination with low-GI miscellaneous grains can also easily lead to poor palatability and poor fusion, which cannot satisfy people's pursuit for excellent taste.

Therefore, it is desirable to provide a preparation method of low-GI rice, which reduces the GI of rice through processing indica paddy rice while preserving its natural characteristics and excellent taste, so as to provide an ideal staple food for diabetic patients and other health-conscious consumers.

### SUMMARY

In order to solve the above-mentioned technical problems, embodiments of the present disclosure provide a preparation method of a low-glycemic index (GI) rice, where indica paddy rice is used as a raw material, which has a relatively high content of amylose, preparation steps are easy to operate, and a product has prominent taste and low GI. The method comprises: S1) washing indica paddy rice to remove impurities, soaking the indica paddy rice in water at 20° C. to 25° C. for 9 h to 10 h to obtain first indica paddy rice, and after the soaking, subjecting the first indica paddy rice to an ultrasonic treatment in water with a first preset volume to obtain second indica paddy rice; S2) after the ultrasonic treatment is completed, filtering out the second indica paddy rice, and cooking the second indica paddy rice in water with a second preset volume for 20 min to 40 min to obtain third indica paddy rice; S3) placing the third indica paddy rice in a vacuum bag for sealing, and subjecting the third indica paddy rice in the vacuum bag to an ultra-high pressure treatment at 450 MPa to 600 MPa for 30 min to 35 min in an autoclave filled with water with a third preset volume to obtained fourth indica paddy rice; S4) air-cooling the fourth indica paddy rice, and refrigerating the fourth indica paddy rice in a refrigerator at 0° C. to 4° C. for 45 h to 50 h to obtained fifth indica paddy rice; S5) after the refrigerating is completed, spreading the fifth indica paddy rice on a stainless steel wire mesh with a spreading thickness of 0.5 cm, oven-drying the fifth indica paddy rice in a blast air oven at 30° C. to 35° C. for 1 h, stopping blast, maintaining a temperature of the blast air oven unchanged, performing tempering treatment on the fifth indica paddy rice for 4 h to 5 h, and then oven-drying the fifth indica paddy rice in the blast air oven at 30° C. to 35° C. until a moisture content of the fifth indica paddy rice is less than 16% to obtain sixth indica paddy rice; and S6) shelling the sixth indica paddy rice to obtain the low-GI rice.

Embodiments of the present disclosure provide a GI rice, which is prepared by the above preparation method.

### BRIEF DESCRIPTION OF THE DRAWINGS

The present disclosure is further illustrated by way of exemplary embodiments, which is described in detail through the drawings. These embodiments are non-limiting, and in these embodiments, same reference numerals denote same structures, wherein:

FIG. 1 is flowchart illustrating a process of a preparation method of a low-glycemic index (GI) rice according to some embodiments of the present disclosure;

FIG. 2 is a schematic diagram illustrating a process for determining a gelatinization degree according to some embodiments of the present disclosure;

FIG. 3A and FIG. 3B are images illustrating appearance comparison between the low-GI rice prepared by some embodiments of the present disclosure and common indica rice, where FIG. 3A is for the common indica rice and FIG. 3B is for the low-GI rice;

FIG. 4A and FIG. 4B are ion chromatograms of volatile components of the low-GI rice prepared by some embodiments of the present disclosure and common indica rice, where FIG. 4A is for the common indica rice and FIG. 4B is for the low-GI rice; and

FIG. 5 is a schematic diagram illustrating aroma components and relative contents thereof in the low-GI rice prepared by some embodiments of the present disclosure and common cooked indica rice.

### DETAILED DESCRIPTION OF THE EMBODIMENTS

For ease of understanding, the technical solutions of the present disclosure are described in detail below with reference to the examples and the accompanying drawings.

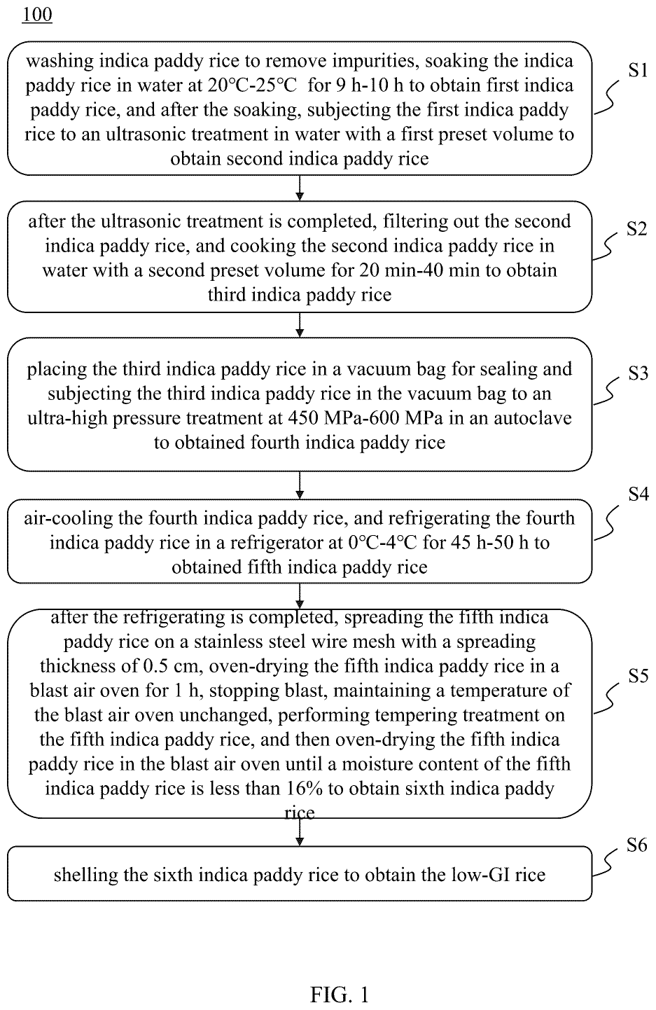

FIG. 1 is flowchart illustrating a process of a preparation method of a low-glycemic index (GI) rice according to some embodiments of the present disclosure. As shown in FIG. 1, a process 100 includes following operations.

S1) washing indica paddy rice to remove impurities, soaking the indica paddy rice in water at 20° C. to 25° C. for 9 h to 10 h to obtain first indica paddy rice, and after the soaking, subjecting the first indica paddy rice to an ultrasonic treatment in water with a first preset volume to obtain second indica paddy rice.

The first indica paddy rice refers to soaked indica paddy rice.

In some embodiments, a temperature of the soaking is within a range of 20° C. to 25° C. in some embodiments, the temperature of the soaking is within a range of 22° C. to 25° C. For example, the temperature of the soaking includes 20° C., 22° C., 25° C., etc., which may be set according to actual needs.

In some embodiments, a time of the soaking is within a range of 9 h to 10 h. In some embodiments, the time of the soaking is within a range of 9 h to 9.5 h, a range of 9.5 h to 10 h, etc. For example, the time of the soaking includes 9 h, 9.5 h, 10 h, etc., which may be set according to actual needs.

The first preset volume may be set according to actual needs. For example, the first preset volume of water is sufficient to submerge the first indica paddy rice.

In some embodiments, a power range of the ultrasonic treatment is 400 W to 600 W. In some embodiments, the power range of the ultrasonic treatment may also be 500 W to 600 W, 500 W to 550 W, 550 W to 600 W, etc. The power of the ultrasonic treatment may be set according to actual needs. For example, the power of the ultrasonic treatment includes 400 W, 500 W, 550 W, 600 W, etc.

In some embodiments, a duration of the ultrasonic treatment is 30 min. The duration of the ultrasonic treatment may be set according to actual needs.

In some embodiments, the power range of the ultrasonic treatment is 400 W to 600 W, and the duration of the ultrasonic treatment is 30 min, which can effectively alter the structure of starch in the first indica paddy rice, preparing for subsequent reduction of GI.

In some embodiments, the power of the ultrasonic treatment is determined from the power range based on a total amount of the first indica paddy rice.

The total amount of the first indica paddy rice includes a weight of the first indica paddy rice.

In some embodiments, the power of the ultrasonic treatment may be determined from the power range through multiple approaches based on the total amount of the first indica paddy rice. For example, the power of the ultrasonic treatment may be determined from the power range by querying a preset relationship table based on the total amount of the first indica paddy rice.

In some embodiments, the preset relationship table may include a correspondence between the total amount of the first indica paddy rice and the power of the ultrasonic treatment. The preset relationship table may be determined based on the total amount of the first indica paddy rice and the actual power of the ultrasonic treatment from historical data.

The power of the ultrasonic treatment is determined from the power range by querying the preset relationship table based on the total amount of the first indica paddy rice, which can ensure that the power of the ultrasonic treatment is matched with the total amount of the first indica paddy rice, thereby improving the effect and quality of the ultrasonic treatment.

In some embodiments, a plurality of candidate ultrasonic parameters are generated based on the total amount of the first indica paddy rice; a processing effect of each candidate ultrasonic parameter is determined through an evaluation model based on composition characteristics of the first indica paddy rice, the total amount of the first indica paddy rice, and each candidate ultrasonic parameter; and the power of the ultrasonic treatment and the duration of the ultrasonic treatment are determined based on the processing effects of the plurality of candidate ultrasonic parameters.

Candidate ultrasonic parameters refer to pre-screened optional combinations of ultrasonic treatment parameters based on the total amount of the first indica paddy rice. For example, candidate ultrasonic parameters include the power of the ultrasonic treatment, the duration of the ultrasonic treatment, etc.

In some embodiments, the plurality of candidate ultrasonic parameters may be generated through multiple approaches based on the total amount of the first indica paddy rice. For example, based on the total amount of the first indica paddy rice, combinations of multiple candidate power and multiple candidate duration of the ultrasonic treatment are randomly generated within a numerical range of historical data to form the plurality of candidate ultrasonic parameters.

The numerical range of historical data may be determined through prior experiments. Random generation method includes normal random generation, pseudo-random number generators, etc.

The composition characteristics refer to parameters used to measure properties of different components or elements in indica paddy rice. For example, composition characteristics include at least one of a moisture content or a grain hardness.

The processing effect refers to a specific effect or result achieved by the processed first indica paddy rice after processing the first indica paddy rice according to the plurality of candidate ultrasonic parameters. For example, the processing effect may include a crystallinity and a whole grain rate of the paddy rice after ultrasonic treatment (e.g., the second indica paddy rice). Higher crystallinity and higher whole grain rate indicate a better processing effect.

The crystallinity refers to a proportion of ordered crystalline structures in starch granules of indica paddy rice, which may be measured by X-ray diffraction (XRD). Starch granules with a high crystallinity are more difficult to be hydrolyzed into sugars, thus leading to slow digestion and absorption, making them suitable for producing low-GI foods.

The whole grain rate refers to a percentage of a mass of intact rice grains (unbroken and undamaged) in a total mass of rice produced during the processing of indica paddy rice.

In some embodiments, the processing effect of each candidate ultrasonic parameter may be determined through multiple approaches based on the composition characteristics of the first indica paddy rice, the total amount of the first indica paddy rice, and each candidate ultrasonic parameter. For example, the processing effect of each candidate ultrasonic parameter is determined through an evaluation model based on the composition characteristics of the first indica paddy rice, the total amount of the first indica paddy rice, and each candidate ultrasonic parameter.

The evaluation model is a machine learning model. For example, the evaluation model is a Deep Neural Network (DNN) model, etc.

In some embodiments, an input of the evaluation model may include the composition characteristics of the first indica paddy rice, the total amount of the first indica paddy rice, and each candidate ultrasonic parameter. The output of the evaluation model is the processing effect of each candidate ultrasonic parameter.

In some embodiments, the evaluation model may be obtained by training based on a large number of labeled training samples. By inputting a plurality of labeled training samples into an initial evaluation model, a value of a loss function is determined based on labels and evaluation results of the initial evaluation model, and the initial evaluation model is iteratively updated based on the value of the loss function. The model training is completed when a preset condition is met, thereby obtaining a trained evaluation model. The preset condition may be a convergence of the loss function, a number of iterations reaching a threshold, etc.

In some embodiments, the training samples for training the evaluation model may be sample composition characteristics of sample first indica paddy rice, sample total amount of sample first indica paddy rice, and sample candidate ultrasonic parameters from historical sample data. The historical sample data may be determined from historical data corresponding to a plurality of historical ultrasonic treatments. The labels are an actual processing effect. The actual processing effect may be an average value of the processing effects of the indica paddy rice (e.g., the second indica paddy rice) after the plurality of historical ultrasonic treatments corresponding to the aforementioned sample candidate ultrasonic parameters.

In some embodiments, the power of the ultrasonic treatment and the duration of the ultrasonic treatment may be determined through multiple approaches based on the processing effects of multiple candidate ultrasonic parameters. For example, after normalizing the crystallinity and the whole grain rate of the second indica paddy rice, a weighted summation is performed, and the power of the ultrasonic treatment and the duration of the ultrasonic treatment corresponding to the candidate ultrasonic parameter with a maximum weighted sum are taken as the power of the ultrasonic treatment and the duration of the ultrasonic treatment parameters during the ultrasonic treatment.

The normalization method includes min-max normalization, etc. The weight coefficients involved in the weighted summation may be set according to experience.

By comprehensively considering the total amount of the first indica paddy rice, the composition characteristics of the first indica paddy rice, and the candidate ultrasonic parameters, the evaluation model is used to predict and evaluate the processing effects of the candidate ultrasonic parameters, so as to obtain the optimal power and the optimal duration of the ultrasonic treatment, achieving the efficiency and precision of ultrasonic treatment.

In some embodiments, in S1, the first indica paddy rice is subjected to rinsing treatment to remove underfilled indica paddy rice.

For example, the rinsing treatment may be performed by water flow rinsing. By adjusting a water flow rate and a rinsing time, the underfilled first indica paddy rice is carried away by the water flow due to its light weight, while the plump first indica paddy rice settles down, thus achieving separation.

Underfilled indica paddy rice usually contains less starch, with lower nutritional value and a lower contribution to low-GI rice. Removing underfilled first indica paddy rice through rinsing treatment is beneficial to improving quality and stability of the subsequent prepared low-GI rice.

S2) after the ultrasonic treatment is completed, filtering out the second indica paddy rice, and cooking the second indica paddy rice in water with a second preset volume for 20 min to 40 min to obtain third indica paddy rice.

The second indica paddy rice refers to paddy rice obtained by performing ultrasonic treatment on the first indica paddy rice.

The second preset volume is similar to the first preset volume, which is not repeated here.

The third indica paddy rice refers to paddy rice obtained by cooking the second indica paddy rice.

In some embodiments, a duration of the cooking may be within a range of 22 min to 38 min. In some embodiments, the duration of the cooking may also be within a range of 20 min to 22 min, a range of 22 min to 30 min, a range of 30 min to 38 min, a range of 38 min to 40 min, etc. The duration of the cooking may be set according to actual needs. For example, the duration of the cooking is 20 min, 22 min, 30 min, 38 min, 40 min, etc.

In some embodiments, stage cooking parameters are determined based on the gelatinization degree, composition characteristics, and structural characteristics of the second indica paddy rice; and the second indica paddy rice is placed into water with the second preset volume for stage cooking based on the stage cooking parameters to obtain the third indica paddy rice.

The gelatinization degree refers to an index used to measure a degree of ripeness of indica paddy rice.

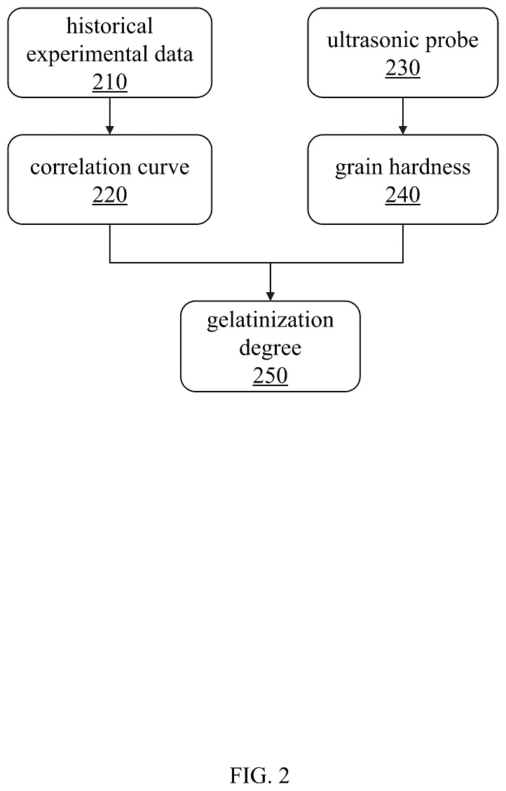

In some embodiments, the gelatinization degree may be obtained by professional technicians through sampling and experimental calculation. For example, calculating a percentage of gelatinized starch content in the total starch content of indica paddy rice. For more information on the gelatinization degree, refer to FIG. 2 and its related description.

The structural characteristics refer to indicators describing internal and external morphology of the indica paddy rice. For example, the structural characteristics include a viscosity and a shape of the indica paddy rice.

The stage cooking parameters refer to operating conditions during different cooking processes. For example, the stage cooking parameters include a temperature and a time for each cooking stage.

In some embodiments, the stage cooking parameters may be determined through multiple approaches based on the gelatinization degree, the composition characteristics, and the structural characteristics of the second indica paddy rice. For example, a first feature vector is constructed based on the gelatinization degree, the composition characteristics, and the structural characteristics of the second indica paddy rice, and then the stage cooking parameters are determined by retrieving in a first vector database based on the first feature vector.

In some embodiments, the first vector database includes a plurality of first reference vectors and reference stage cooking parameters corresponding to each first reference vector.

In some embodiments, first reference vectors are constructed based on historical gelatinization degrees, historical composition characteristics, and historical structural characteristics of different second indica paddy rice in historical data. Among multiple historical cooking operations actually corresponding to the first reference vector, the historical actual stage cooking parameters for which the subsequent prepared low-GI rice meets a first quality condition are used as the reference stage cooking parameters.

The first quality condition may be characterized by a weighted sum of the gelatinization degree and the whole grain rate of the subsequently prepared low-GI rice, with weights preset by professional technicians. The low-GI rice meeting the first quality condition includes that: the weighted sum of the gelatinization degree and the whole grain rate of the low-GI rice is maximized.

In some embodiments, the stage cooking parameters corresponding to the first feature vector are determined by calculating a similarity between the first reference vector and the first feature vector. For example, the first reference vector whose similarity to the first feature vector meets a first preset condition is used as a first target vector, and the reference stage cooking parameters corresponding to the first target vector are used as the stage cooking parameters corresponding to the first feature vector. The first preset condition may be determined according to the situation. For example, the first preset condition may be that the similarity is greater than a preset similarity threshold, etc. The similarity between the first reference vector and the first feature vector may be negatively correlated with a vector distance between the first reference vector and the first feature vector, and the vector distance may be determined based on a cosine distance, etc. For example, the similarity may be a reciprocal of the vector distance.

The stage cooking parameters are determined based on the gelatinization degree, the composition characteristics, and the structural characteristics of the second indica paddy rice and stage cooking is performed, which helps to more precisely control the cooking process of the second indica paddy rice, thereby better adapting to the characteristics of different batches of indica paddy rice.

S3) placing the third indica paddy rice in a vacuum bag for sealing and subjecting the third indica paddy rice in the vacuum bag to an ultra-high pressure treatment at 450 MPa to 600 MPa in an autoclave to obtained fourth indica paddy rice.

The fourth indica paddy rice refers to indica paddy rice obtained by performing the ultra-high pressure treatment on the third indica paddy rice.

In some embodiments, the autoclave contains water with a third preset volume, and a duration of the ultra-high pressure treatment is within a range of 30 min to 50 min. In some embodiments, the duration of the ultra-high pressure treatment may be set according to actual needs. For example, the duration of ultra-high pressure treatment is 30 min, 40 min, 50 min, etc.

The third preset volume is similar to the first preset volume, which is not repeated here.

In some embodiments, a temperature of the ultra-high pressure treatment is within a range of 50° C. to 60° C. In some embodiments, the temperature of the ultra-high pressure treatment may be set according to actual needs.

In some embodiments, at each preset cycle, the temperature of the ultra-high pressure treatment in a next preset cycle is determined based on the gelatinization degree and the composition characteristics of the fourth indica paddy rice.

The preset cycle refers to a fixed time interval set in a continuous production process to adjust process parameters (e.g., a temperature of the ultra-high pressure treatment) according to real-time monitored characteristics (e.g., a gelatinization degree and composition characteristics) of intermediate products of low-GI rice. In some embodiments, the preset cycle may be set according to actual needs. For example, the preset cycle is 3 min, 5 min, etc.

In some embodiments, at each preset cycle, the temperature of the ultra-high pressure treatment in the next preset cycle may be determined through multiple approaches based on the gelatinization degree and the composition characteristics of the fourth indica paddy rice. For example, a second feature vector is constructed based on the gelatinization degree and the composition characteristics of the fourth indica paddy rice, and then the temperature of the ultra-high pressure treatment in the next preset cycle is determined by retrieving in a second vector database based on the second feature vector.

In some embodiments, the second vector database includes a plurality of second reference vectors and a reference temperature of the ultra-high pressure treatment corresponding to each second reference vector.

In some embodiments, second reference vectors are constructed based on historical gelatinization degrees and historical composition characteristics of different fourth indica paddy rice in historical data. Among multiple historical ultra-high pressure treatment operations actually corresponding to the second reference vector, the historical actual temperature of the ultra-high pressure treatment for which the subsequent prepared low-GI rice meets a second quality condition are used as the reference temperature of the ultra-high pressure treatment.

The second quality condition may be characterized by a weighted sum of a resistant starch content and a whole grain rate of the subsequently prepared low-GI rice, with the weights preset by professional technicians. The low-GI rice quality meeting the second quality condition includes that: the weighted sum of the resistant starch content and the whole grain rate of the low-GI rice is maximized.

The resistant starch content refers to a percentage of the resistant starch content in the total starch content of low-GI rice.

In some embodiments, the temperature of the ultra-high pressure treatment corresponding to the second feature vector is determined by calculating a similarity between the second reference vector and the second feature vector. For example, the second reference vector whose similarity to the second feature vector meets a second preset condition is used as a second target vector, and the reference temperature of the ultra-high pressure treatment corresponding to the second target vector is used as the temperature of the ultra-high pressure treatment corresponding to the second feature vector. The second preset condition is similar to the first preset condition, and the determination method of the similarity between the second reference vector and the second feature vector is similar to that of the similarity above, which is not repeated here.

By adjusting the temperature of the ultra-high pressure treatment in the next preset cycle based on the gelatinization degree and composition characteristics of the fourth indica paddy rice at each preset cycle, the processing of the paddy rice can be precisely controlled, further optimizing the quality of the subsequently prepared low-GI rice and improving production efficiency and stability.

The temperature of the ultra-high pressure treatment is limited to a range of 50° C. to 60° C., which can ensure that the indica paddy rice achieves an ideal gelatinization degree and ideal physicochemical properties during processing, thereby contributing to obtaining better low-GI rice.

S4) air-cooling the fourth indica paddy rice, and refrigerating the fourth indica paddy rice in a refrigerator at 0° C. to 4° C. for 45 h to 50 h to obtained fifth indica paddy rice.

In some embodiments, a time of the refrigerating may be within a range of 45 h to 48 h, a range of 48 h to 50 h, etc. The time of the refrigerating may be set according to actual needs. For example, the time of the refrigerating includes 45 h, 48 h, 50 h, etc.

The temperature of the refrigerator may be set according to actual needs, for example, 0° C., 2° C., 4° C., etc.

The fifth indica paddy rice refers to refrigerated indica paddy rice.

S5) after the refrigerating is completed, spreading the fifth indica paddy rice on a stainless steel wire mesh with a spreading thickness of 0.5 cm, oven-drying the fifth indica paddy rice in a blast air oven for 1 h, stopping blast, maintaining a temperature of the blast air oven unchanged, performing tempering treatment on the fifth indica paddy rice, and then oven-drying the fifth indica paddy rice in the blast air oven until a moisture content of the fifth indica paddy rice is less than 16% to obtain sixth indica paddy rice.

The sixth indica paddy rice refers to oven-dried indica paddy rice.

In some embodiments, a temperature of the oven-drying is within a range of 30° C. to 35° C. The temperature of the oven-drying may be set according to actual needs. For example, the temperature of the oven-drying is 30° C., 32° C., 35° C., etc.

In some embodiments, a time of the tempering treatment is within a range of 4 h to 5 h. The time of the tempering treatment may be set according to actual needs. For example, the time of the tempering treatment is 4 h, 4.5 h, 5 h, etc.

In some embodiments, the oven-drying further includes performing stage drying on the fifth indica paddy rice in the blast air oven based on stage drying parameters.

In some embodiments, the stage drying parameters include at least one of a drying temperature or a drying time for each oven-drying. In some embodiments, the stage drying parameters may be set according to actual needs.

In some embodiments, the stage drying parameters include the drying temperature of 30° C.-35° C. and a preset drying time.

The preset drying time may be set by professional and technical personnel according to the actual demand.

The stage drying using stage drying parameters can more precisely control the drying process of the fifth indica paddy rice, avoiding excessive oven-drying or insufficient oven-drying, and improving the quality of the subsequent prepared low-GI rice.

In some embodiments, after 1 h of oven-drying, the blast is stopped and the tempering treatment is performed. The tempering treatment allows the moisture inside the indica paddy rice (e.g., the fifth indica paddy rice) to fully diffuse outward, avoiding the formation of an outer shell due to rapid drying of the outer layer, which can affect outward diffusion of the interior moisture of the indica paddy rice. During this process, there is sufficient time for starch molecules in the indica paddy rice to fully bind and undergo recrystallization aging, effectively reducing enzymatic degradation of starch (i.e., lowering starch digestibility) and decreasing the GI value. Additionally, it ensures uniform moisture content from the core to the outer layer of the indica paddy rice, avoiding the crack of indica paddy rice and reducing the broken rice rate, thereby effectively improving the head rice yield.

S6) shelling the sixth indica paddy rice to obtain the low-GI rice.

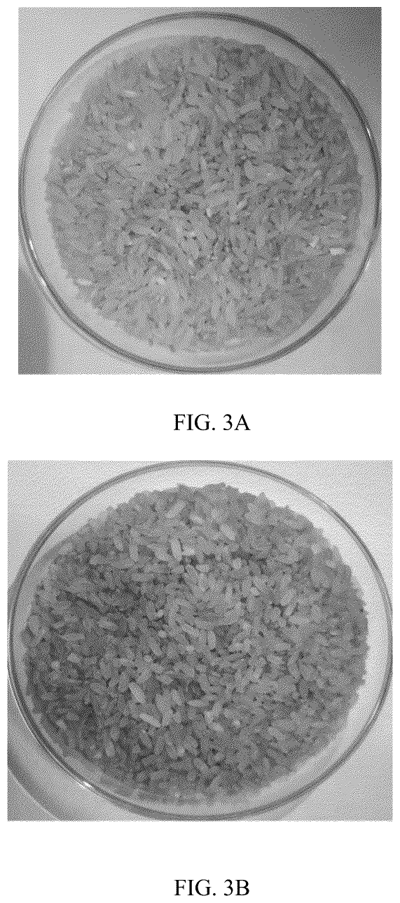

FIG. 3A and FIG. 3B are images illustrating appearance comparison between the low-GI rice prepared by some embodiments of the present disclosure and common indica rice, where FIG. 3A is for the common indica rice and FIG. 3B is for the low-GI rice.

The low-GI rice refers to an indica paddy rice product whose GI is less than or equal to a preset threshold through specific processing techniques. The preset threshold may be determined by querying international standards; for example, the preset threshold is 55.

In some embodiments, a shelling device (e.g., a rice huller, etc.) is selected to shell the sixth indica paddy rice to obtain low-GI rice.

In some embodiments, after S3 and before S4, the preparation method further includes: performing stage drying on the fourth indica paddy rice in a blast air oven based on stage drying parameters.

The stage drying was added based on stage drying parameters after step S3 and before step S4, which can improve drying efficiency and uniformity, optimize the quality of the fourth indica paddy rice, and enhance the controllability and stability of the production process.

Soaking and ultrasonic treatment help change the structure of starch in the indica paddy rice, promoting water penetration and starch pre-modification; cooking and ultra-high pressure treatment can further affect the gelatinization degree and crystalline structure of starch in the indica paddy rice; refrigerating helps stabilize changes in the crystalline structure; and oven-drying helps ensure the dryness and long-term storage stability of the subsequently prepared low-GI rice, thereby completely preserving the natural nutrients of the indica paddy rice. Through the above steps, this method can produce rice products with low-GI characteristics, thereby helping to control blood glucose levels and providing diabetic patients with staple food choices with complete nutrition retention and excellent quality.

FIG. 2 is a schematic diagram illustrating a process for determining a gelatinization degree according to some embodiments of the present disclosure.

In some embodiments, as shown in FIG. 2, a correlation curve 220 is determined based on historical experimental data 210; the grain hardness 240 of the fourth indica paddy rice is determined using an ultrasonic probe 230; and the gelatinization degree 250 of the fourth indica paddy rice is determined based on the grain hardness 240 of the fourth indica paddy rice and the correlation curve 220.

The historical experimental data include historical grain hardness and historical gelatinization degree in multiple historical experiments.

In some embodiments, the correlation curve characterizes a relationship between the grain hardness and the gelatinization degree. The abscissa of the correlation curve is the grain hardness, and the ordinate of the correlation curve is the gelatinization degree.

In some embodiments, a fitting algorithm is used to fit the historical experimental data to obtain a correlation curve between the grain hardness and the gelatinization degree. The fitting algorithm include least square method, regularized linear regression, polynomial fitting, etc.

The ultrasonic probe refers to a probe built in the ultra-high pressure treatment equipment.

In some embodiments, the ultrasonic probe is configured to measure the grain hardness.

In some embodiments, the gelatinization degree of the fourth indica paddy rice may be determined through multiple approaches based on the grain hardness of the fourth indica paddy rice and the correlation curve. For example, the gelatinization degree corresponding to the current grain hardness on the correlation curve is found and determined as the gelatinization degree of the fourth indica paddy rice.

By the pre-established correlation curve between the grain hardness and the gelatinization degree, the measured current grain hardness can be easily mapped to the corresponding gelatinization degree, improving the accuracy of determining the gelatinization degree.

In some embodiments, a low-GI rice is provided, which is prepared by the preparation method in the above embodiments.

### Example 1

A preparation method of a low-GI rice was provided, including the following steps.

S1. Indica paddy rice was washed to remove impurities, and then 500 g of washed indica paddy rice was taken and soaked in room-temperature water at 22° C. to 25° C. for 9 h, such that water molecules slowly penetrated into the interior of the indica paddy rice; after the soaking, the indica paddy rice was rinsed to remove underfilled indica paddy rice; and resulting indica paddy rice were subjected to an ultrasonic treatment in water with the first preset volume at 500 W for 30 min.

S2. After the ultrasonic treatment was completed, the indica paddy rice was filtered out and cooked in water with the second preset volume for 30 min.

S3. After the cooking is completed, the indica paddy rice treated in S2 was placed in a vacuum bag for sealing, then the vacuum bag was placed in an autoclave, where a volume of water in the autoclave was larger than a volume of the indica paddy rice, such that the indica paddy rice fully absorbed water during the ultra-high pressure treatment to promote the gelatinization; and the indica paddy rice in the vacuum bag was subjected to an ultra-high pressure treatment at 300 MPa and 50° C. for 30 min, which was conducive to the gelatinization of starch in the paddy rice.

S4. The indica paddy rice treated in S3 was air-cooled, and then refrigerated in a refrigerator at 0° C. to 4° C. for 45 h.

S5. After the refrigerating was completed, the indica paddy rice treated in S4 was oven-dried in a blast air oven at 30° C. until a moisture content in the indica paddy rice was less than 16%.

S6. The indica paddy rice treated in S5 was shelled to obtain the desired low-GI rice.

### Example 2

A preparation method of a low-GI rice was provided, including the following steps.

S1. Indica paddy rice was washed to remove impurities, and then 500 g of washed indica paddy rice was taken and soaked in room-temperature water at 20° C. to 25° C. for 10 h, such that water molecules slowly penetrated into the interior of the indica paddy rice; after the soaking, the indica paddy rice was rinsed to remove underfilled indica paddy rice; and resulting indica paddy rice were subjected to an ultrasonic treatment in water with the first preset volume at 550 W for 30 min.

S2. After the ultrasonic treatment was completed, the indica paddy rice was filtered out and cooked in water with the second preset volume for 38 min.

S3. After the cooking is completed, the indica paddy rice treated in S2 was placed in a vacuum bag for sealing, then the vacuum bag was placed in an autoclave, where a volume of water in the autoclave was larger than a volume of the indica paddy rice, such that the indica paddy rice fully absorbed water during the ultra-high pressure treatment to promote the gelatinization; and the indica paddy rice in the vacuum bag was subjected to an ultra-high pressure treatment at 400 MPa and 50° C. for 30 min, which was conducive to the gelatinization of starch in the paddy rice.

S4. The indica paddy rice treated in S3 was air-cooled, and then refrigerated in a refrigerator at 0° C. to 4° C. for 48 h.

S5. After the refrigerating was completed, the indica paddy rice treated in S4 was oven-dried in a blast air oven at 35° C. until a moisture content in the indica paddy rice was less than 16%.

S6. The indica paddy rice treated in S5 was shelled to obtain the desired low-GI rice.

### Example 3

A preparation method of a low-GI rice was provided, including the following steps.

S1. Indica paddy rice was washed to remove impurities, and then 500 g of washed indica paddy rice was taken and soaked in room-temperature water at 20° C. to 25° C. for 9.5 h, such that water molecules slowly penetrated into the interior of the indica paddy rice; after the soaking, the indica paddy rice was rinsed to remove underfilled indica paddy rice; and resulting indica paddy rice were subjected to an ultrasonic treatment in water with the first preset volume at 6000 W for 30 min.

S2. After the ultrasonic treatment was completed, the indica paddy rice was filtered out and cooked in water with the second preset volume for 22 min.

S3. After the cooking is completed, the indica paddy rice treated in S2 was placed in a vacuum bag for sealing, then the vacuum bag was placed in an autoclave, where a volume of water in the autoclave was larger than a volume of the indica paddy rice, such that the indica paddy rice fully absorbed water during the ultra-high pressure treatment to promote the gelatinization; and the indica paddy rice in the vacuum bag was subjected to an ultra-high pressure treatment at 500 MPa and 50° C. for 30 min, which was conducive to the gelatinization of starch in the paddy rice.

S4. The indica paddy rice treated in S3 was air-cooled, and then refrigerated in a refrigerator at 0° C. to 4° C. for 48 h.

S5. After the refrigerating was completed, the indica paddy rice treated in S4 was oven-dried in a blast air oven at 35° C. until a moisture content in the indica paddy rice was less than 16%.

S6. The indica paddy rice treated in S5 was shelled to obtain the desired low-GI rice.

### Example 4

A preparation method of a low-GI rice was provided, including the following steps.

S1. Indica paddy rice was washed to remove impurities, and then 500 g of washed indica paddy rice was taken and soaked in room-temperature water at 20° C. to 25° C. for 9.5 h, such that water molecules slowly penetrated into the interior of the indica paddy rice; after the soaking, the indica paddy rice was rinsed to remove underfilled indica paddy rice; and resulting indica paddy rice were subjected to an ultrasonic treatment in water with the first preset volume at 600 W for 30 min.

S2. After the ultrasonic treatment was completed, the indica paddy rice was filtered out and placed in a vacuum bag for sealing, then the vacuum bag was placed in an autoclave, where a volume of water in the autoclave was larger than a volume of the indica paddy rice, such that the indica paddy rice fully absorbed water during the ultra-high pressure treatment to promote the gelatinization; and the indica paddy rice in the vacuum bag was subjected to an ultra-high pressure treatment at 500 MPa and 50° C. for 30 min, which was conducive to the gelatinization of starch in the indica paddy rice.

S3. The indica paddy rice treated in S2 was cooked in water with the second preset volume for 22 min.

S4. The indica paddy rice treated in S3 was air-cooled, and then refrigerated in a refrigerator at 0° C. to 4° C. for 48 h.

S5. After the refrigerating was completed, the indica paddy rice treated in S4 was oven-dried in a blast air oven at 35° C. until a moisture content in the indica paddy rice was less than 16%.

S6. The indica paddy rice treated in S5 was shelled to obtain the desired low-GI rice.

### Example 5

A preparation method of a low-GI rice was provided, including the following steps.

S1. Indica paddy rice was washed to remove impurities, and then 500 g of washed indica paddy rice was taken and soaked in room-temperature water at 20° C. to 25° C. for 9.5 h, such that water molecules slowly penetrated into the interior of the indica paddy rice; after the soaking, the indica paddy rice was rinsed to remove underfilled indica paddy rice.

S2. The indica paddy rice was filtered out and cooked in water with the second preset volume for 22 min.

S3. After the cooking is completed, the indica paddy rice treated in S2 was subjected to an ultrasonic treatment in water with the first preset volume at 600 W for 30 min.

S4. After the ultrasonic treatment is completed, the indica paddy rice was filtered out and placed in a vacuum bag for sealing, then the vacuum bag was placed in an autoclave, where a volume of water in the autoclave was larger than a volume of the indica paddy rice, such that the indica paddy rice fully absorbed water during the ultra-high pressure treatment to promote the gelatinization; and the indica paddy rice in the vacuum bag was subjected to an ultra-high pressure treatment at 500 MPa and 50° C. for 30 min, which was conducive to the gelatinization of starch in the indica paddy rice.

S5. The indica paddy rice obtained after the ultra-high pressure treatment was air-cooled, and then refrigerated in a refrigerator at 0° C. to 4° C. for 48 h.

S6. After the refrigerating was completed, the indica paddy rice treated in S5 was oven-dried in a blast air oven at 35° C. until a moisture content in the indica paddy rice was less than 16%.

S6. The indica paddy rice treated in S6 was shelled to obtain the desired low-GI rice.

### Example 6

A preparation method of a low-GI rice was provided, including the following steps.

S1. Indica paddy rice was washed to remove impurities, and then 500 g of washed indica paddy rice was taken and soaked in room-temperature water at 20° C. to 25° C. for 9.5 h, such that water molecules slowly penetrated into the interior of the indica paddy rice; after the soaking, the indica paddy rice was rinsed to remove underfilled indica paddy rice.

S2. the indica paddy rice treated in S1 was cooked in water with the second preset volume for 22 min.

S3. The indica paddy rice after the cooking was placed in a vacuum bag for sealing, then the vacuum bag was placed in an autoclave, where a volume of water in the autoclave was larger than a volume of the indica paddy rice, such that the indica paddy rice fully absorbed water during the ultra-high pressure treatment to promote the gelatinization; and the indica paddy rice in the vacuum bag was subjected to an ultra-high pressure treatment at 500 MPa and 50° C. for 30 min, which was conducive to the gelatinization of starch in the paddy rice.

S4. The indica paddy rice after the ultra-high pressure treatment was air-cooled, and then refrigerated in a refrigerator at 0° C. to 4° C. for 48 h.

S5. After the refrigerating was completed, the indica paddy rice was oven-dried in a blast air oven at 35° C. until a moisture content in the indica paddy rice was less than 16%.

S6. The indica paddy rice treated in S5 was shelled to obtain the desired low-GI rice.

### Example 7

A preparation method of a low-GI rice was provided, including the following steps.

S1. Indica paddy rice was washed to remove impurities, and then 500 g of washed indica paddy rice was taken and soaked in room-temperature water at 20° C. to 25° C. for 9.5 h, such that water molecules slowly penetrated into the interior of the indica paddy rice; after the soaking, the indica paddy rice was rinsed to remove underfilled indica paddy rice; and then the indica paddy rice was subjected to an ultrasonic treatment in water with the first preset volume at 600 W for 30 min.

S2. After the ultrasonic treatment is completed, the indica paddy rice is filtered out and cooked in water with the second preset volume for 22 min.

S3. After the cooking was completed, the indica paddy rice treated in S2 was refrigerated in a refrigerator at 0° C. to 4° C. for 48 h.

S4. After the refrigerating was completed, the indica paddy rice treated in S3 was oven-dried in a blast air oven at 35° C. until a moisture content in the indica paddy rice was less than 16%.

S5. The indica paddy rice treated in S4 was shelled to obtain the desired low-GI rice.

### Example 8

A preparation method of a low-GI rice was provided, including the following steps.

S1. Indica paddy rice was washed to remove impurities, and then 500 g of washed indica paddy rice was taken and soaked in room-temperature water at 20° C. to 25° C. for 9.5 h, such that water molecules slowly penetrated into the interior of the indica paddy rice; after the soaking, the indica paddy rice was rinsed to remove underfilled indica paddy rice; and then the indica paddy rice was subjected to an ultrasonic treatment in water with the first preset volume at 600 W for 30 min.

S2. After the ultrasonic treatment was completed, the indica paddy rice was filtered out and cooked in water with the second preset volume for 22 min.

S3. The indica paddy rice after the cooking was placed in a vacuum bag for sealing, then the vacuum bag was placed in an autoclave, where a volume of water in the autoclave was larger than a volume of the indica paddy rice, such that the indica paddy rice fully absorbed water during the ultra-high pressure treatment to promote the gelatinization; and the indica paddy rice in the vacuum bag was subjected to an ultra-high pressure treatment at 500 MPa and 70° C. for 30 min, which was conducive to the gelatinization of starch in the paddy rice.

S4. The indica paddy rice after the ultra-high pressure treatment was air-cooled, and then refrigerated in a refrigerator at 0° C. to 4° C. for 48 h.

S5. After the refrigerating was completed, the indica paddy rice was oven-dried in a blast air oven at 35° C. until a moisture content in the indica paddy rice was less than 16%.

S6. The indica paddy rice treated in S5 was shelled to obtain the desired low-GI rice.

### Example 9

A preparation method of a low-GI rice was provided, including the following steps.

S1. Indica paddy rice was washed to remove impurities, and then 500 g of washed indica paddy rice was taken and soaked in room-temperature water at 20° C. to 25° C. for 9.5 h, such that water molecules slowly penetrated into the interior of the indica paddy rice; after the soaking, the indica paddy rice was rinsed to remove underfilled indica paddy rice; and then the indica paddy rice was subjected to an ultrasonic treatment in water with the first preset volume at 600 W for 30 min.

S2. After the ultrasonic treatment was completed, the indica paddy rice was filtered out and cooked in water with the second preset volume for 22 min.

S3. The indica paddy rice after the cooking was placed in a vacuum bag for sealing, then the vacuum bag was placed in an autoclave, where a volume of water in the autoclave was larger than a volume of the indica paddy rice, such that the indica paddy rice fully absorbed water during the ultra-high pressure treatment to promote the gelatinization; and the indica paddy rice in the vacuum bag was subjected to an ultra-high pressure treatment at 500 MPa and 50° C. for 30 min, which was conducive to the gelatinization of starch in the paddy rice.

S4. The indica paddy rice after the ultra-high pressure treatment was air-cooled, and then refrigerated in a refrigerator at 0° C. to 4° C. for 48 h.

S5. After the refrigerating was completed, the following blast drying method was performed.

S51. The indica paddy rice was spread on a stainless steel wire mesh with a spreading thickness of 0.5 cm, and then dried in a blast air oven at 35° C. for 1 h.

S52. The blast was stopped, the temperature of the blast air oven was maintained at 30° C. to 35° C., and the indica paddy rice was subjected to tempering treatment for 4 h to 5 h.

S53. The blast was turned on, the indica paddy rice continued to be dried at 30° C. to 35° C., and the blast drying was terminated when the moisture content of the indica paddy rice was less than 16%.

S6. The indica paddy rice treated in S5 was shelled to obtain the desired low-GI rice.

### Example 10

A preparation method of a low-GI rice was provided, including the following steps.

S1. Indica paddy rice was washed to remove impurities, and then 500 g of washed indica paddy rice was taken and soaked in room-temperature water at 20° C. to 25° C. for 9.5 h, such that water molecules slowly penetrated into the interior of the indica paddy rice; after the soaking, the indica paddy rice was rinsed to remove underfilled indica paddy rice; and then the indica paddy rice was subjected to an ultrasonic treatment in water with the first preset volume at 600 W for 30 min.

S2. After the ultrasonic treatment was completed, the indica paddy rice was filtered out and cooked in water with the second preset volume for 22 min.

S3. The indica paddy rice after the cooking was placed in a vacuum bag for sealing, then the vacuum bag was placed in an autoclave, where a volume of water in the autoclave was larger than a volume of the indica paddy rice, such that the indica paddy rice fully absorbed water during the ultra-high pressure treatment to promote the gelatinization; and the indica paddy rice in the vacuum bag was subjected to an ultra-high pressure treatment at 500 MPa and 50° C. for 30 min, which was conducive to the gelatinization of starch in the paddy rice.

S4. After the ultra-high pressure treatment was completed, the following blast drying method was conducted on the indica paddy rice treated in S3.

S41. The indica paddy rice was spread on a stainless steel wire mesh with a spreading thickness of 0.5 cm, and then dried in a blast air oven at 35° C. for 1 h.

S42. The blast was stopped, the temperature of the blast air oven was maintained at 30° C. to 35° C., and the indica paddy rice was subjected to tempering treatment for 4 h to 5 h.

S43. The blast was turned on, the indica paddy rice continued to be dried at 30° C. to 35° C., and the blast drying was terminated when the moisture content of the indica paddy rice was less than 16%.

S5. The indica paddy rice treated in S4 was air-cooled, and then refrigerated in a refrigerator at 0° C. to 4° C. for 48 h.

S6. The indica paddy rice treated in S5 was shelled to obtain the desired low-GI rice.

The physicochemical properties of the low-GI rice prepared in each of Examples 1 to 10 were analyzed, and the common cooked indica rice was adopted as a control. The low-GI rice prepared in Examples 1-3 and the common cooked indica rice in the control group were subjected to the following determinations: water absorption rate, viscosity and elasticity, analysis of aroma components, and sensory evaluation of cooked rice. The determination results are as follows. It can be seen that the Examples 1-3 of the present disclosure exhibit good preparation effects, and the prepared rice is comparable to common rice, with good adaptability for various populations. Meanwhile, to verify the impact of different processes on a GI value and a broken rice rate of the prepared rice, the low-GI rice prepared in Examples 1-10 and the common cooked indica rice in the control group were subjected to further experimental verification (such as determination of the GI value and determination of a head rice yield). The determination results for each experiment are as follows.

### 1. Determination of Water Absorption Rate

Experimental method: 20 g of cleaned rice in each of the experimental groups 1 to 3 (the low-GI rice prepared in examples 1 to 3) and the control group (the common cooked indica rice) was accurately weighed and soaked for 20 min, then the surface water was immediately removed with a paper towel, and then the rice was spread in a clean petri dish, subjected to water equilibrium in a vacuum drying oven at 37° C. for 1 h, taken out and air-cooled, and weighed. A ratio of a weight difference of rice before and after water absorption to the weight of original rice was the water absorption rate.

Water absorption rate of rice (%)=(weight of rice after water absorption-weight of rice before water absorption)/weight of rice before water absorption×100%.

Results are shown in Table 1, and it can be seen from the table that a water absorption rate of the low-GI rice prepared by examples of the present disclosure is slightly higher than that of the common indica rice.

TABLE 1
Water absorption rate of low-GI rice

| Group | Water absorption rate/% |
|---|---|
| Example 1 | 20.32 |
| Example 2 | 22.21 |
| Example 3 | 21.19 |
| Control | 20.29 |

### 2. Determination of Viscosity and Elasticity

The texture characteristics of the cooked rice were determined using a TA-XT2i texture analyzer (SMS, UK). The rice cooking was conducted in accordance with the national standard GB/T15682-2008. 20 g of rice was taken and washed three times, then washed rice was mixed with water in a rice-to-water ratio of 1:1.3, and a resulting mixture was placed in an aluminum box (90 mm in diameter and 50 mm in height) and then cooked in a steamer. 10 rice grains were randomly selected from different positions of the aluminum box and placed symmetrically on an object stage of the texture analyzer for test, where there was a specified interval among the rice grains and 5 parallel tests were conducted for each sample.

Test results are shown in Table 2, and it can be seen that the elasticity and hardness of the low-GI rice prepared by examples of the present disclosure are not much different from those of the common indica rice obtained after normal cooking.

TABLE 2
Elasticity and hardness of low-GI rice

| Group | Elasticity value/mm | Hardness value/g |
|---|---|---|
| Example 1 | 0.41 | 2310 |
| Example 2 | 0.43 | 2423 |
| Example 3 | 0.49 | 2532 |
| Control | 0.42 | 3531 |

### 3. Determination of Aroma Components

Sample preparation: the low-GI rice prepared by examples of the present disclosure and the common indica rice were each crushed, sieved through a 100-mesh sieve, and placed in a dry and sealed pot for later use. 3 g of a sample was added into a 10 mL headspace vial, and then the headspace vial was capped and sealed for later use.

Solid phase microextraction (SPME) conditions: the headspace vial filled with the sample was equilibrated in a constant-temperature water bath at 80° C. for 1 h, then an extraction head was inserted into the headspace vial to allow extraction for 50 min, and analysis was conducted at an injection port of GC-MS for 5 min.

Gas chromatography (GC) conditions: the HP-5 MS capillary chromatography column was used as a capillary column, and a carrier gas flow rate was 1 mL/min. Temperature program: an initial temperature of the column was 50° C., and then the temperature was continuously raised to 125° C. at 8° C./min and held for 3 min, then raised to 165° C. at 4° C./min and held for 3 min, and finally raised to 250° C. at 10° C./min and held for 2 min; and a non-splitting mode was adopted.

Mass spectrometry (MS) conditions: interface temperature: 280° C.; ion source: electron ionization (EI); ion source temperature: 230° C.; electron energy: 70 eV; scanning range (m/z): 35 amu to 500 amu; and using full-scan acquisition mode.

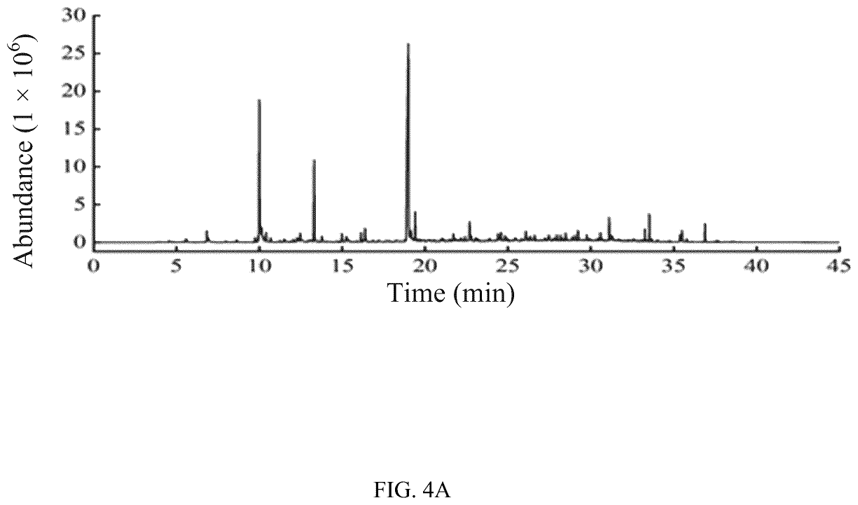

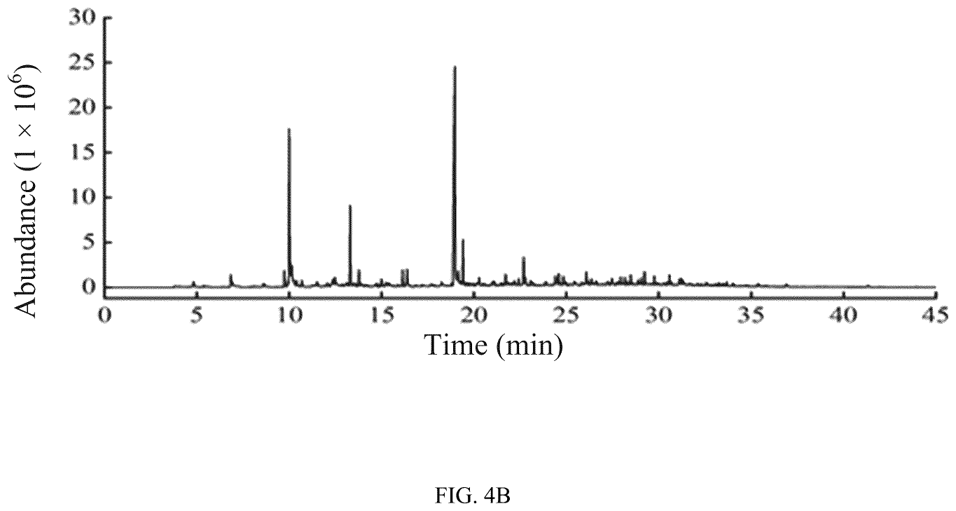

FIG. 4A and FIG. 4B are ion chromatograms of volatile components of the low-GI rice prepared by some embodiments of the present disclosure and common indica rice, where FIG. 4A is for the common indica rice and FIG. 4B is for the low-GI rice.

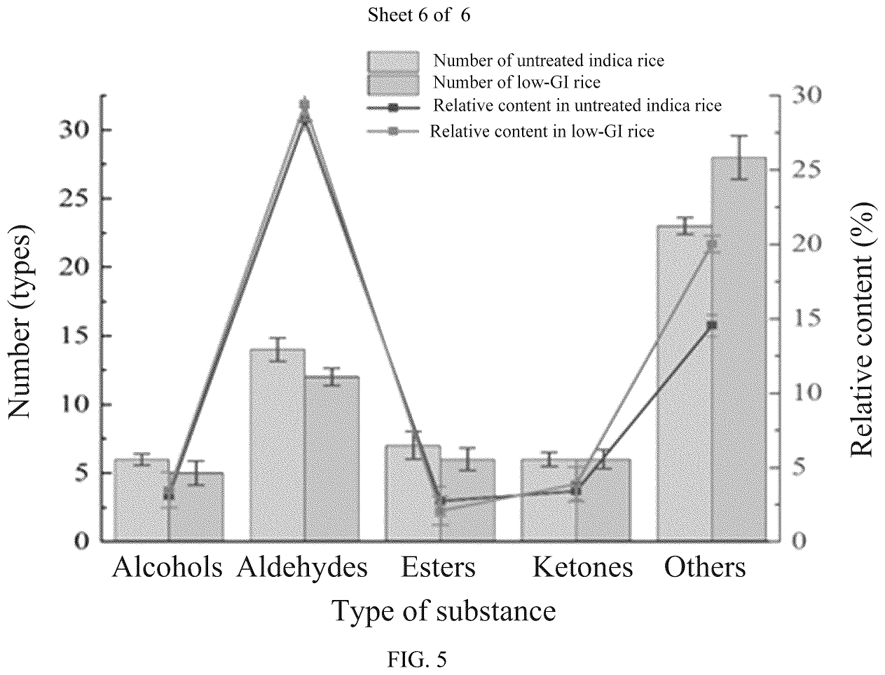

FIG. 5 is a schematic diagram illustrating aroma components and relative contents thereof in the low-GI rice prepared by some embodiments of the present disclosure and common cooked indica rice.

The aroma components in rice were qualitatively detected. A total of 57 volatile components were detected in the low-GI rice, and a total of 56 volatile components were detected in the common indica rice in the control group, as shown in FIG. 4A, FIG. 4B, FIG. 5, and Table 3, indicating that the low-GI rice prepared by the preparation method of the present disclosure has little aroma loss, ensuring the nutrition and aroma components of the low-GI rice.

TABLE 3
Relative volatile component contents and aroma
characteristics of low-GI rice

| | | | | Relative content/% | |
|---|---|---|---|---|---|
| | | Retention | | Low-GI | |
| Type | No. | time/min | Compound name | rice | Control |
| Alcohols | 1 | 10.149 | 1-Octen-3-ol | 1.21 | 0.71 |
| | 2 | 19.722 | 2-Hexyl-1-decanol | 0.30 | — |
| | 3 | 22.425 | Myristyl alcohol | 0.58 | 0.42 |
| | 4 | 26.086 | 1-Pentadecanol | 1.27 | 1.05 |
| | 5 | 29.046 | 1-Hexadecanol | 0.11 | 0.46 |
| | 6 | 7.982 | n-Hexanol | — | 0.15 |
| | 7 | 23.051 | 1-Heptadecanol | — | 0.36 |
| Aldehydes | 1 | 6.836 | Hexanal | 1.12 | 1.05 |
| | 2 | 8.633 | Heptanal | 0.19 | 0.17 |
| | 3 | 9.737 | Cis-2-heptenal | 1.33 | 0.41 |
| | 4 | 10.009 | Benzaldehyde | 15.61 | 14.89 |
| | 5 | 10.686 | Octanal | 0.50 | 0.38 |
| | 6 | 12.066 | Trans-2-octenal | 0.37 | 0.28 |
| | 7 | 13.315 | Nonanal | 7.15 | 8.16 |
| | 8 | 15.271 | Phenylpropanal | 0.48 | 0.59 |
| | 9 | 15.249 | Decanal | 1.53 | 1.31 |
| | 10 | 17.19 | Trans-cinnamaldehyde | 0.36 | 0.35 |
| | 11 | 18.253 | Trans-2-decenal | 0.48 | — |
| | 12 | 21.828 | 2-Butyl-2-octenal | 0.28 | — |
| | 13 | 11.887 | Phenylacetaldehyde | — | 0.15 |
| | 14 | 16.852 | (E,E)-2,4-nonadienal | — | 0.25 |
| | 15 | 18.801 | 4-tert-Butylbenzaldehyde | — | 0.22 |
| | 16 | 19.711 | Undecanal | — | 0.21 |
| Ketones | 1 | 10.254 | Methylheptenone | 0.29 | 0.25 |
| | 2 | 11.513 | 3-Octen-2-one | 0.48 | 0.33 |
| | 3 | 12.351 | 3,5-Octadien-2-one | 0.79 | 0.30 |
| | 4 | 12.473 | Acetophenone | 1.06 | 1.21 |
| | 5 | 33.688 | Phytone | 0.28 | 0.15 |
| | 6 | 24.412 | Geranyl acetone | 0.98 | 0.82 |
| | 7 | 5.591 | Acetoin | — | 0.35 |
| Esters | 1 | 15.422 | Vinyl benzoate | 0.51 | — |
| | 2 | 25.444 | Ethyl cinnamate | 0.64 | 0.57 |
| | 3 | 27.224 | Butyl tetradecanoate | 0.27 | — |
| | 4 | 33.263 | Octyl salicylate | 0.25 | 0.89 |
| | 5 | 34.01 | Diisobutyl phthalate | 0.19 | — |
| | 6 | 35.376 | Dibutyl phthalate | 0.23 | — |
| | 7 | 4.569 | Vinyl acetate | — | 0.30 |
| | 8 | 12.286 | Octyl formate | — | 0.56 |
| | 9 | 15.426 | Methyl benzoylformate | — | 0.23 |
| | 10 | 35.781 | Ethyl palmitate | — | 0.19 |
| Others | 1 | 4.836 | Trichloromethane | 0.83 | — |
| | 2 | 5.353 | Triethylamine | 0.15 | — |
| | 3 | 8.17 | m-Xylene | 0.09 | — |
| | 4 | 8.598 | Styrene | 0.33 | — |
| | 5 | 10.419 | 2-pentylfuran | 0.44 | — |
| | 6 | 11.463 | D-terpadiene | 0.12 | — |
| | 7 | 13.114 | Undecane | 0.25 | — |
| | 8 | 16.143 | Dodecane | 0.25 | 0.86 |
| | 9 | 14.72 | 5-Methylundecane | 0.30 | — |
| | 10 | 14.856 | 4-Methylundecane | 0.17 | — |
| | 11 | 15.224 | 3-Methylundecane | 0.34 | — |
| | 12 | 27.944 | 3 -Methylpentadecane | — | 0.64 |
| | 13 | 29.931 | Cedrol | — | 0.16 |
| | 14 | 16.145 | Dodecane | 1.38 | — |
| | 15 | 19.134 | 1-Tridecene | 0.65 | 0.43 |
| | 16 | 19.408 | n-Tridecane | 4.00 | 2.68 |
| | 17 | 19.881 | 2-Methylnaphthalene | — | 0.10 |
| | 18 | 22.776 | 5,5-Dibutylnonane | — | 0.57 |
| | 19 | 20.287 | Heptamethylnonane | 0.65 | — |
| | 20 | 21.076 | Cyclohexylheptane | 0.37 | — |
| | 21 | 24.977 | 4-Methyltetradecane | 0.99 | 1.09 |
| | 22 | 22.691 | Tetradecane | 2.64 | 1.93 |
| | 23 | 22.779 | 3-Methyltetradecane | 0.80 | — |
| | 24 | 35.378 | Palmitic acid | — | 0.75 |
| | 25 | 23.053 | 1-Heptadecene | 0.42 | — |
| | 26 | 33.607 | 5,9,13-Trimethyl-4,8,12- | — | 0 10 |
| | | | tetradecatrienyl | | |
| | 27 | 23.179 | 1-Nonadecene | 0.31 | 0.27 |
| | 28 | 23.053 | 10-Methyleicosane | 0.39 | — |
| | 29 | 26.353 | Pentadecane | 0.65 | 0.56 |
| | 30 | 33.09 | 5,5-Diethylpentadecane | — | 0.13 |
| | 31 | 28.167 | Nonylcyclohexane | 0.60 | 0.52 |
| | 32 | 32.571 | Undecylcyclohexane | — | 0.15 |
| | 33 | 28.487 | 3-Methylpentadecane | 0.78 | 0.51 |
| | 34 | 29.233 | Hexadecane | 1.05 | 0.90 |
| | 35 | 30.579 | Cyclohexadecane | — | 0.60 |
| | 36 | 31.303 | 2,2′,5,5′- | — | 0.36 |
| | | | Tetramethylbiphenyl | | |
| | 37 | 30.581 | Undecanylcyclopentane | 0.73 | — |
| | 38 | 31.303 | 2,2′,5,5′- | 0.33 | — |
| | | | Tetramethylbiphenyl | | |
| | 39 | 3.794 | Ammonium carbamate | — | 0.18 |
| | 40 | 10.417 | 2-Pentylfuran | — | 0.76 |
| | 41 | 16.301 | Naphthalene | — | 0.28 |

Note:
“—” means that it is not detected.

### 4. Sensory Determination of Rice

### Sensory Evaluation

### 1. Preparation Before the Evaluation

1) Evaluator introduction: 5 men and 5 women with tasting experience that were at an age of 23 to 30 and in good health and had no bad habits were selected.

2) Conditions: the mouth of each evaluator was rinsed with warm boiled water before each evaluation to remove residues in the mouth.

### 2. Evaluation Content

1) Identification of a smell of cooked rice: the cooked rice was placed under the nose of an evaluator while hot, and then the evaluator inhaled appropriately and carefully identified a smell of the cooked rice.

2) Observation of appearance of cooked rice: the color, gloss, and rice grain integrity of cooked rice were observed.

3) Identification of palatability of cooked rice: a little amount of cooked rice was put in the mouth with chopsticks and chewed carefully for 3 s to 5 s, during which an evaluator carefully evaluated the viscosity, softness/hardness, elasticity, taste, and the like of cooked rice with sensory organs such as teeth and tongue while chewing.

4) Texture of cooled cooked rice: the rice was placed at room temperature for 1 h, and then the viscoelasticity, agglomeration, and hardness of the cooled cooked rice were determined by tasting.

### 3. Scoring

Comprehensive scoring was conducted according to the smell, appearance structure, palatability, taste of cooked rice, and the texture of cooled cooked rice, and an average value was calculated according to the comprehensive scoring results of each evaluator. Scores of some evaluators with large errors (10 points higher than the average value) could be discarded, and then an average value was recalculated. Finally, an average value of comprehensive scores was used as a result of sensory evaluation of the edible quality of rice, and a calculation result was rounded to an integer.

The scoring rules were as follows in table 4.

TABLE 4
Sensory evaluation scoring rules for rice

| First-level index value | Second-level index value | Specific description; score |
|---|---|---|
| Smell: 15 points | Smell: 15 points | Strong and long-lasting rice aroma: 15 to 12 points |
| | | Rice aroma that is weak and inapparent and easily |
| | | disappears: 11 to 8 points |
| | | No rice aroma: 7 to 5 points |
| | | Unpleasant smell: 4 to 0 point |
| Appearance: 15 points | Color and smell: 15 points | Moderate color, prominent gloss, and easy |
| | | dispersion: 15 to 10 points |
| | | Dark color and poor gloss: 9 to 5 points |
| | | Unsightly color and no gloss: 4 to 0 point |
| Palatability: 30 points | Softness/Hardness: 10 points | Moderate hardness and prominent taste: 10 to 8 |
| | | points |
| | | Slightly hard or slightly soft: 7 to 5 points |
| | | Too hard and too soft: 4 to 0 point |
| | Elasticity: 10 points | Highly elastic: 10 to 8 points |
| | | Generally elastic: 7 to 5 points |
| | | Inelastic: 4 to 0 point |
| | Viscosity: 10 points | Viscous and agglomerated: 10 to 8 points |
| | | Viscous and loose: 7 to 5 points |
| | | Non-viscous and loose: 4 to 0 point |

The results are shown in Table 5, and it can be seen that the sensory evaluation of the low-GI rice prepared in examples of the present disclosure generally meets the requirements of the general public.

TABLE 5
Sensory evaluation scores for rice

| Name | Sensory evaluation | Score |
|---|---|---|
| Example 1 | Moderate hardness, rich aroma, and prominent taste | 85 |
| Example 2 | Moderate hardness, and rich and layered taste | 82 |
| Example 3 | Moderate hardness, easy dispersion, and prominent taste | 81 |
| Control | Moderate hardness, excellent elasticity, and prominent | 82 |
| | taste | |

The low GI rice prepared in Examples 1-10 was tested, and the common cooked indica rice was used as a control for the experiment.

### 1. Determination of GI Value

Each of the low-GI rice and the common cooked indica rice was thoroughly crushed and sieved through a 100-mesh sieve to obtain a low-GI rice flour and a common cooked indica rice flour. With 200 mg of white bread crushed in the same way as a reference, 200 mg of the low-GI rice flour and 200 mg of the common cooked indica rice flour were accurately weighed and added to a 50 mL centrifuge tube, respectively, and then 20 mL of phosphate buffered saline (PBS, 0.12 mol/L NaCl, 2.7 mmol/L KCl, and 0.01 mol/L phosphate) was added. A pH was adjusted to 1.5 with 1 mol/L HCl, and a resulting mixture was thoroughly shaken; 0.2 mL of a pepsin solution (115μ/mL) was added, a resulting mixture was incubated in a water bath at 37° C. for 30 min, and then the sample was taken out and cooled to room temperature. A pH was adjusted to 6.86 with 1 mol/L NaOH, then 1 mL of a a-amylase solution (110μ/mL) was added, and a volume was increased to 50 mL with PBS (pH=6.9). A resulting solution was shaken in a constant-temperature water bath at 37° C. for 1 h, and then 500 μL of a sample was collected every 30 min during a period of 0 to 3 h after the shaking (6 times in total); 1.5 mL of 0.4 mol/L of a sodium acetate buffer (pH=4.75) was added per mL of a sample solution, then 30 μL of glucoamylase (110μ/mL) was added, and a resulting mixture was shaken in a constant-temperature water bath at 50° C. for 30 min. A content was then diluted to 10 mL with distilled water, 1 μL of a resulting sample was taken and mixed with 1 mL of a glucose oxidase/peroxidase (GOPOD) reagent, and a resulting mixture was then incubated at 37° C. for 15 min; and the absorbance was determined at 510 nm. In this section, the kit was used instead of the mean value for plotting a curve, and then an area under the curve (AUC) was calculated with glucose (0.2 g) as a standard carbohydrate. A predicted GI of a test sample prepared by each preparation method was calculated by dividing an AUC of the test sample with an AUC of glucose in white bread. Results are shown in Table 6, and it can be seen that a GI value of the low-GI rice prepared by examples of the present disclosure is significantly lower than that of the common indica rice in the control group.

### 2. Determination of Head Rice Yield

Appropriate amounts of low-GI rice and common cooked indica rice were randomly weighed and processed with a rice mill for 1.5 min, and then bran and debris were sieved out using a bamboo sieve. The broken and incomplete rice grains were manually removed, the samples were weighed and recorded three times, and the average was calculated.

Head rice yield:

$$H = ( 1 - \frac{{W}_{1}}{{W}_{0}} ) \times 100 \% ,$$

W₁ is a weight of broken rice, and W₀ is a total weight of the sample.

After processing by the rice mill, there is another condition in the rice: the grain being intact but having surface cracks, called cracked grains, commonly known as burst grains. The crackle ratio was determined by referring to the method in GB/T 5496-1985.

TABLE 6
Determination results of GI value and head rice yield of low-GI rice

| Group | GI value | Head rice yield/% | Crackle ratio/% |
|---|---|---|---|
| Example 1 | 51 | 97.43 | 4.0 |
| Example 2 | 48 | 97.12 | 3.8 |
| Example 3 | 46 | 96.01 | 3.6 |
| Example 4 | 62 | 90.32 | 7.9 |
| Example 5 | 65 | 87.46 | 13.6 |
| Example 6 | 66 | 92.8 | 3.9 |
| Example 7 | 72 | 96.14 | 3.3 |
| Example 8 | 61 | 91.53 | 5.7 |
| Example 9 | 44 | 97.65 | 1.6 |
| Example 10 | 65 | 97.12 | 1.9 |
| Control | 76 | 95.1 | 4.5 |

As show in table 6, the low-GI rice prepared in the examples of the present disclosure has a GI value of less than 55, making it suitable for consumption by diabetic patients and meeting the staple food needs of special populations. In addition, the low-GI rice obtained according to the examples of the present disclosure has little aroma loss, retaining its nutrients and aroma components.

In the technical solution of the present disclosure, indica paddy rice is first cooked to gelatinize the starch, followed by ultra-high pressure treatment to promote starch molecular rearrangement and water absorption, laying the foundation for refrigeration retrogradation, and ultimately achieving a lower GI value.

When the process sequence is altered, both the GI value and broken rice rate change significantly. In Example 4, indica paddy rice is first subjected to ultra-high pressure treatment and then cooked. The ultra-high pressure treatment is applied to ungelatinized starch. Although high pressure partially disrupts starch granules, the ungelatinized starch molecules cannot fully rearrange. This leads to insufficient retrogradation after subsequent cooking and reduces formation of resistant starch, causing the GI value to increase. Additionally, by the ultra-high pressure treatment (500 MPa), the high pressure is applied on ungelatinized hard grains, which is easy to cause internal stress cracks. The thermal effect of subsequent cooking amplifies these defects, resulting in increasing rice breakage, thereby increasing the broken rice rate. In the original technical solution, the grains are softened by cooking first, and the ultra-high pressure treatment is performed more uniformly, which can reduce breakage of rice grains.

In Example 5, indica paddy rice is first cooked and then subjected to ultrasonic treatment (600 W, 30 min), resulting in an increased GI value and significantly increased broken rice rate. Ultrasonic treatment utilizes cavitation effects to promote water penetration, ensuring uniform starch gelatinization during cooking and ultra-high pressure treatment. When the process sequence is altered, cooking first make the starch gelatinized and the grain softened, and ultrasonic treatment (600 W, 30 min) physically destroys the gelatinized gel structure, resulting in the fracture of starch granules and the increase of soluble starch. This reduces formation of resistant starch during refrigeration retrogradation, making the starch more digestible and raising the GI value. For the softened grains after cooking, the structure of rice grains is fragile, and mechanical vibration of high-power ultrasound (600 W) can easily lead to the fracture or surface damage of rice grains, resulting in the decrease of head rice rate and the increase of the crackle ratio.

In Example 6, ultrasonic treatment is removed, leading to an increased GI value and a slightly increased broken rice rate. The absence of ultrasonic treatment results in insufficient water penetration inside the rice, causing uneven starch gelatinization during cooking and ultra-high pressure treatment. Some areas are not fully gelatinized, refrigeration retrogradation is incomplete, and the formation of resistant starch is reduced. Additionally, due to insufficient water penetration, cooking and ultra-high pressure treatment may lead to localized stress concentration, which increases the risk of grain breakage to some extent. Although removing ultrasonic treatment alleviates some mechanical damage, gelatinization is uneven due to insufficient water penetration, the difference in drying shrinkage increases microcracks, resulting in a slight increase in the crackle ratio.

In Example 7, when removing the ultra-high pressure treatment, the GI value is significantly increased, while the broken rice rate remains basically unchanged. The ultra-high pressure treatment is a core step for forming low-GI rice. The ultra-high pressure treatment (500 MPa, 50° C.) promotes starch gelatinization and molecular rearrangement, enhancing starch chain interactions and facilitating formation of resistant starch during refrigeration. Without the ultra-high pressure treatment, only ultrasonic treatment, cooking, and refrigeration are insufficient to modify starch adequately, the degree of starch retrogradation is low, the content of resistant starch is greatly reduced, and the starch is more easily hydrolyzed by enzyme, so that the GI value of the prepared rice is close to that of common cooked rice.

In Example 8, increasing the temperature of the ultra-high pressure treatment causes an increase in both the GI value and the broken rice rate. Excessive temperature (70° C.) causes partial starch over-gelatinization or gelation, or even degradation into small-molecule sugars, reducing retrogradation potential. During refrigeration, the formation of resistant starch is insufficient, starch digestion is accelerated, and the GI value is increased. The combination of high temperature (70° C.) and high pressure (500 MPa) induces thermal stress, excessively softening the grain structure and causing expansion rupture under the ultra-high pressure. Subsequent thermal shrinkage during refrigeration and drying amplifies the damage. The temperature range (30-50° C.) of the ultra-high pressure treatment selected in the present disclosure is milder, balancing starch gelatinization and structural integrity.

In Example 9, introducing stage drying and tempering treatment causes a significantly reduction in both GI value and broken rice rate. On the one hand, the stage drying can promote uniform retrogradation: tempering after air drying allowing moisture to migrate from the grain core to the surface, preventing the formation of a shell of the grain due to rapid outer-layer drying, so as to avoid hindering internal moisture evaporation during subsequent low-temperature drying, enabling starch molecules to rearrange sufficiently and forming a more complete resistant starch structure. On the other hand, tempering can release internal stress in grains, protecting the formed resistant starch network. The stage drying and tempering treatment extends the drying time, providing enough time for starch molecules to fully bond and undergo recrystallization and aging, thus effectively reducing enzymatic degradation of starch (i.e., decreasing digestibility of starch) and significantly increasing resistant starch content. Additionally, rapid dehydration during grain drying causes uneven shrinkage between the inside and outside of the grain, generating stress cracks (commonly known as burst grains). During the tempering treatment, moisture is redistributed, causing that water content from the core to the outer layer of grains is equalized, and the internal stress is released, greatly reducing the crack risk.

In Example 10, blast drying was performed on indica paddy rice before refrigeration, reducing the broken rice rate but significantly increasing the GI value. By blast drying, the moisture content of the paddy rice is less than 16%, the hardness of the paddy rice is significantly improved. The shrinkage stress of the subsequent refrigeration has little effect on the hardened rice grains, which can reduce the broken rice rate and the crackle ratio. The GI value significantly increases because the formation of resistant starch requires to meet two conditions: gelatinized starch being at high moisture state (the moisture content>30%) and slowly rearranged at low temperature (0-10° C.). The paddy rice is dried first to have a moisture content less than 16%, causing starch granules to dehydrate and solidify (i.e., glass transition). When refrigerating at this time, the water activity is too low, the movement of starch molecules is frozen, orderly retrogradation cannot occur, and the content of resistant starch is extremely low, which is close to that of common rice.

It can be seen from the above that the implementation of the process “soaking-ultrasonic treatment-cooking-ultra-high pressure treatment-blast drying-refrigeration” described in the present disclosure is indispensable for preparing low-GI rice with a low broken rice rate. Omitting any step or altering any step sequence in this process leads to change in the GI value or an increase in the broken rice rate, thereby affect the technical effects.

In the present disclosure, soaking is first performed, followed by ultrasonic treatment. The ultrasonic treatment helps water penetrate the grains, making subsequent cooking and ultra-high pressure treatment more effective and promoting uniform starch gelatinization and retrogradation. Removing ultrasonic treatment causes insufficient water penetration, uneven gelatinization, less retrogradation, and reduced resistant starch, thus increasing the GI value. Cooking and the ultra-high pressure treatment facilitate starch gelatinization and molecular rearrangement, facilitating formation of resistant starch during refrigeration. Omitting the ultra-high pressure treatment or the pressure/temperature of the ultra-high pressure treatment not reaching the optimal pressure/temperature range results in inadequate or excessive gelatinization, affecting both GI value and head rice yield. Refrigeration after the ultra-high pressure treatment allows gelatinized starch to retrograde under the optimal moisture condition. After retrogradation, the rice is dried by blast drying. On the one hand, there is enough time to fully combine the starch molecules in the grain and fully recrystallize and age, thus effectively reducing the enzymatic degradation of starch molecules, that is, reducing the digestibility of starch. On the other hand, the moisture content of the grain from the inner to the outer layer is uniform, which avoids the burst of the grain and reduces the broken rice rate, thus effectively improving the head rice rate.

The present disclosure has the following beneficial effects.

1. The ultrasonic treatment can change an internal tissue structure of indica paddy rice and break cells, and the auxiliary soaking can shorten a time for indica paddy rice to absorb water and greatly shorten a soaking time of indica paddy rice during cooking, thereby speeding up the product preparation process. The longer the ultrasonic time, the higher the moisture content in rice grains. The indica paddy rice absorbs enough water in a short time, such that the starch in indica paddy rice can be fully gelatinized in the later cooking. The ultrasonic treatment also helps increase the whole grain rate of indica paddy rice.

2. The cooking based on ultrasonic treatment can significantly shorten the optimal cooking time for acquiring low-GI rice, reduce the influence of cooking on the texture characteristics and sensory quality of rice, and promote the release of starch in paddy rice during cooking to some degree.

3. In the ultra-high pressure treatment, a volume of water in the container is larger than a volume of indica paddy rice, which facilitates the indica paddy rice to fully absorb water during the ultra-high pressure treatment and promotes the gelatinization. The ultra-high pressure treatment is conducted at a temperature of 50° C. to 60° C. and a pressure of 300 MPa to 400 MPa, which is favorable for the gelatinization of starch in rice, can shorten the cooking time and improve the appearance quality of cooked rice, and is an available potential technology for producing high-quality rice. In addition, the ultra-high pressure treatment greatly increases a content of resistant starch in indica paddy rice, improves a nutritional value of indica paddy rice, and conforms to the concept of low-GI food. Moreover, the ultra-high pressure treatment leads to a stable sterilization effect, and can retain the original flavor and nutrition of the food, improve the taste quality of the prepared low-GI rice to some degree, and promote the absorption of food nutrients by the human body.

4. The refrigeration process is an aging process of starch in indica paddy rice, which can accelerate the aging of gelatinized starch and increase a content of slowly digestible starch (SDS) in indica paddy rice. In addition, under the premise of ensuring the quality of rice, the refrigeration is conducive to the storage of rice.

5. According to test results, the low-GI rice obtained in the present disclosure shows little difference in elasticity and hardness from the normally-cooked rice, has a favorable taste and strong palatability, and is relatively easy to be accepted by consumers.

6. The low-GI rice obtained in the present disclosure has a GI value of less than 55 and is suitable for diabetics, which can satisfy the dependence of special populations on the staple food. According to test by solid-phase microextraction combined with gas chromatography-mass spectrometry (SPME/GC-MS), volatile substances in the obtained low-GI rice are not much different from those in common cooked rice, indicating that the aroma of the rice obtained by the preparation method of the present disclosure does not lose too much, which ensures the nutrition and aroma components of the low-GI indica rice.

7. No extrusion, puffing, recombination, and the like are involved in the whole preparation process of the present disclosure, and the preparation method is simple, has a low cost and a low broken rice rate, and leads to remarkable economic benefits. In addition, no exogenous substance is added in the preparation process, which satisfies the requirements of people who pursue natural food.

The method introduces the stage drying and the tempering treatment, which can further reduce the GI value of rice and reduce the broken rice rate and crackle, effectively improving the quality of prepared low GI rice.

The above implementations are merely used to illustrate the technical solutions of the present disclosure, but not to limit the present disclosure. Although the present disclosure is described in detail with reference to the above implementations, those of ordinary skill in the art should understand that any modification, equivalent substitution, and improvement made within the spirit and principle of the present disclosure shall be included in the protection scope of the present disclosure.

What is claimed is:

1. A preparation method of a low-glycemic index (GI) rice, comprising:
S1) washing indica paddy rice to remove impurities, soaking the indica paddy rice in water at 20° C. to 25° C. for 9 h to 10 h to obtain first indica paddy rice, and after the soaking, subjecting the first indica paddy rice to an ultrasonic treatment in water with a first preset volume to obtain second indica paddy rice;
S2) after the ultrasonic treatment is completed, filtering out the second indica paddy rice, and cooking the second indica paddy rice in water with a second preset volume for 20 min to 40 min to obtain third indica paddy rice;
S3) placing the third indica paddy rice in a vacuum bag for sealing, and subjecting the third indica paddy rice in the vacuum bag to an ultra-high pressure treatment at 450 MPa to 600 MPa for 30 min to 35 min in an autoclave filled with water with a third preset volume to obtained fourth indica paddy rice;
S4) air-cooling the fourth indica paddy rice, and refrigerating the fourth indica paddy rice in a refrigerator at 0° C. to 4° C. for 45 h to 50 h to obtained fifth indica paddy rice;
S5) after the refrigerating is completed, spreading the fifth indica paddy rice on a stainless steel wire mesh with a spreading thickness of 0.5 cm, and oven-drying the fifth indica paddy rice in a blast air oven at 30° C. to 35° C. for 1 h, stopping blast, maintaining a temperature of the blast air oven unchanged, performing tempering treatment on the fifth indica paddy rice for 4 h to 5 h, and then oven-drying the fifth indica paddy rice in the blast air oven at 30° C. to 35° C. until a moisture content of the fifth indica paddy rice is less than 16% to obtain sixth indica paddy rice; and
S6) shelling the sixth indica paddy rice to obtain the low-GI rice.

2. The preparation method according to claim 1, wherein in S1, the ultrasonic treatment is conducted at a power range of 400 W to 600 W for 30 min.

3. The preparation method according to claim 2, further comprising:
determining a power of the ultrasonic treatment from the power range based on a total amount of the first indica paddy rice.

4. The preparation method according to claim 3, wherein the determining a power of the ultrasonic treatment from the power range based on a total amount of the first indica paddy rice includes:
generating a plurality of candidate ultrasonic parameters based on the total amount of the first indica paddy rice;
determining a processing effect of each candidate ultrasonic parameter through an evaluation model based on composition characteristics of the first indica paddy rice, the total amount of the first indica paddy rice, and each candidate ultrasonic parameter; and
determining the power of the ultrasonic treatment and a duration of the ultrasonic treatment based on processing effects of the plurality of candidate ultrasonic parameters.

5. The preparation method according to claim 1, wherein in S1, the first indica paddy rice is rinsed to remove underfilled indica paddy rice.

6. The preparation method according to claim 1, wherein in S3, the ultra-high pressure treatment is conducted at a temperature range of 50° C. to 60° C.

7. The preparation method according to claim 6, further comprising:
at each preset cycle, determining a temperature for the ultra-high pressure treatment in a next preset cycle based on a gelatinization degree and composition characteristics of the fourth indica paddy rice, wherein the composition characteristics include at least one of a moisture content or a grain hardness.

8. The preparation method according to claim 7, further comprising:
determining a correlation curve that characterizes a relationship between the grain hardness and the gelatinization degree based on historical experimental data;
determining a grain hardness of the fourth indica paddy rice using an ultrasonic probe; and
determining the gelatinization degree of the fourth indica paddy rice based on the grain hardness of the fourth indica paddy rice and the correlation curve.

9. The preparation method according to claim 1, wherein in S5, the oven-drying includes:
performing stage drying on the fifth indica paddy rice in the blast air oven based on stage drying parameters, wherein the stage drying parameters include at least one of a drying temperature or a drying time for each oven-drying.

10. The preparation method according to claim 9, wherein the stage drying parameters include the drying temperature of 30° C. to 35° C. and a preset drying time.

11. The preparation method according to claim 1, wherein after S3 and before S4, the preparation method further comprises:
performing stage drying on the fourth indica paddy rice in the blast air oven based on stage drying parameters, wherein the stage drying parameters include at least one of a drying temperature or a drying time for each oven-drying.

12. The preparation method according to claim 1, wherein in S2, the preparation method further comprises:
determining stage cooking parameters based on a gelatinization degree, composition characteristics, and structural characteristics of the second indica paddy rice; and
performing stage cooking on the second indica paddy rice in water with the second preset volume based on the stage cooking parameters to obtain the third indica paddy rice.

13. A low-glycemic index (GI) rice prepared by the preparation method according to claim 1.

14. The low-GI rice according to claim 13, wherein in S1, the ultrasonic treatment is conducted at a power range of 400 W to 600 W for 30 min.

15. The low-GI rice according to claim 14, wherein the preparation method further includes:
determining a power of the ultrasonic treatment from the power range based on a total amount of the first indica paddy rice.

16. The low-GI rice according to claim 13, wherein in S1, the first indica paddy rice is rinsed to remove underfilled indica paddy rice.

17. The low-GI rice according to claim 13, wherein in S3, the ultra-high pressure treatment is conducted at a temperature range of 50° C. to 60° C.

18. The low-GI rice according to claim 17, wherein the preparation method further includes:
at each preset cycle, determining a temperature for the ultra-high pressure treatment in a next preset cycle based on a gelatinization degree and composition characteristics of the fourth indica paddy rice, wherein the composition characteristics include at least one of a moisture content or a grain hardness.

19. The preparation method according to claim 18, wherein the preparation method further includes:
determining a correlation curve that characterizes a relationship between the grain hardness and the gelatinization degree based on historical experimental data;
determining a grain hardness of the fourth indica paddy rice using an ultrasonic probe; and
determining the gelatinization degree of the fourth indica paddy rice based on the grain hardness of the fourth indica paddy rice and the correlation curve.

20. The preparation method according to claim 13, wherein in S5, the oven-drying includes:
performing stage drying on the fifth indica paddy rice in the blast air oven based on stage drying parameters, wherein the stage drying parameters include at least one of a drying temperature or a drying time for each oven-drying.
